(19) United States
(12) Patent Application Publication
(10) Pub. No.: US 2005/0027983 A1
(43) Pub. Date: Feb. 3, 2005

(54) Integrated verification system

(76) Inventor: Kevin T. Klawon, Orlando, FL (US)

Correspondence Address: George R. Royer, Suite 416, 316 N. Michigan Street, Toledo, OH, 43624, US

(21) Appl. No.: 10/633,175

(22) Filed: Aug. 1, 2003

(51) Int. Cl. H04L 9/00

(52) U.S. Cl. 713/168

(57) ABSTRACT

The subject invention comprises a process and means for an integrated and standardized verification rating of individuals seeking credit or access, or for sending a digital signature for access purposes including means comprising of a scaled rating for an individual's identity, along with potential other individual attributes that will be rated in order to apprise a merchant or other entity of the authenticity of the individual seeking credit or permit access to an entity or sending a digital signature.

### BACKGROUND OF INVENTION AND DISCUSSION OF PRIOR ART

As a matter of background, in circumstances where individuals apply for credit there is generally a centralized agency organized to collect payment history of such individuals. Such a credit-reporting agency would then generate credit ratings for individuals so applying as based primarily on payment histories collected in the-respective data banks. Lending or other institutions use the resultant credit rating as an assessment on an individual's propensity for payment of debts in a timely manner. Such information would then be used as the basis to determine if it is feasible to offer credit to the individual consumer in a given situation.

However, by reason of the recent surge in identity theft, there is now a need for a specialized central agency to collect individual consumer information and then generate an identity authentication or verification by way of an identity score, based on a broader array of background information which would provide an institution a wider base of data to ascertain and authenticate an individual's identity and other attributes. This could provide individual authenticity means to verify that he or she is indeed the named or actual individual, whether it was on an application or an electronically signed document. A wide range of information and background data can be used as a broader input for a varying array of characteristics to help in this authentication process which will yield a better basis for individual authenticity rating and other characteristics. One use of such a process would help prevent identity theft by one who attempts to illicitly usurp the identity and credit of another, thus perpetrating a fraud. Institutions that are confronted with this situation of identity misuse would have available, for an identity thief, a low identity score, thus preventing the credit account from even being opened or individual consumer information being changed or access granted. Such a process would protect not only the institutions involved but also the individual and consumers at large.

### OBJECTS OF THE INVENTION

An object of the subject invention is to provide an improved system for demonstrating and affirming the identity of an individual.

A further object of the subject invention is to provide an improved system to provide and maintain a wider array of data and to rate the authenticity of an individual for any purposes;
Still another purpose of the subject invention is to provide an integrated system of authenticating the identity of an individual, together with his or her electronic signature, thereby providing a system that yields an individually secured authenticated signature along with his or her identity rating for institutions and individuals to affirm the identity of an individual using an electronic signature;
Still another purpose of the subject invention is to provide an integrated system of authenticating the identity of an individual, together with his or her overall credit worthiness and thereby providing a system that yields an individually authenticated identity along with his credit rating;
Another object of the subject invention is to provide an improved system for evaluating individuals on an overall basis for any matters;
Another object of the subject invention is to provide an improved system for verifying certain attributes of an individual that need to be verified for individual on an overall basis for any matters;
A further object of the subject invention is to provide an improved rating system for an individual's credit-worthiness;
Yet another object of the subject system is to provide an improved rating system for individual identity verification;
Still another object of the subject invention is to provide an improved system of rating an individual for admission to an institution.

A further object of the subject invention will be apparent from a reading of the description taken in conjunction with the claims.

### DRAWINGS

FIG. 1 is a schematic block diagram of the software processes incorporating aspects of the subject invention.

FIG. 2 is a schematic view of the overall system indicating the relationship between the individual consumer and the processing center and end users of the identity information used in conjunction with the subject system.

### DESCRIPTION OF GENERAL EMBODIMENT AND SUMMARY OF THE INVENTION

The subject invention comprises of a process and means for an integrated and standardized verification rating of individuals seeking credit or access to an entity sending a digital signature by means comprising of a scaled rating for the individual's identity, along with potential other individual attributes that will be rated in order to apprise a merchant or other entity of the authenticity of the individual seeking credit or permit access to an entity or sending a digital signature.

Initially, in an overall perspective, the subject invention is a system of rating an individual for identity purposes and other areas using one or more personal identity characteristics, each such characteristic having a graded scale for rating of that particular characteristic, and then adding an individual rating score for each designated characteristic to provide an overall rating for authentication of identity of the individual. These rating processes can encompass ratings used for credit applications, employment applications, and other institutional admissions or for any other purpose in which an individual applies to or for and is not just limited to those specified above. Included can be requests for employment or admission to school, among a myriad of other circumstances.

In a general perspective, a member institution to which an individual applies, receives an application for a credit card, bank loan, mobile phone service, driver's license system access or requests to change personal information on an existing account, will use this system or other access or admissions. If the applicant is entered in the subject system herein, such individual will be able to register that he or she has applied for credit and/or signed a document for other access with a particular institution, entity or individual. When the central processor in this system receives a request for verification from the member institution there will be an identity authentication score sent back optimally with an additional verification rating, which will be based on a standardized system on a national basis.

The subject invention comprises a process and means for integrated procedures to obtain a standardized identity or credit worthiness rating for individuals seeking credit or for those using electronic signatures or making personal information changes on established accounts or for gaining access to an institution comprising of the steps of utilizing a scaled mathematical or other rating system for such areas. The overall processing system includes basic steps outlined below.

Alternately stated, the subject invention is a system of rating individuals for identity authentication and other personal attributes using one or more personal characteristics, each characteristic having a graded scale for rating of that particular characteristic, and then adding the individual rating score for each designated characteristic to provide an overall rating for authentication of identity of the individual, or additional verification rating attributes areas. This rating process can encompass a rating used for credit applications, matters relating to digital signature of documents, aspects concerning changing of personal information within established third party accounts, matters involving employment applications, and other involvement in institutional admissions or for any other purpose in which an individual applies to or for and is not just limited to those areas specified by way or example. Included in these other areas can be requests for employment, verification for employment, verification of employment, verification of income, or admission to a school, and other areas.

From an overall mathematical or other processing approach, the system herein involves calculating using a procedure to arrive at a combined identification validity rating along with other personal attributes. In this process individuals can be rated for identity as well as for credit worthiness with individual scoring, resulting in a verification rating for other identity and possibly other personal attributes.

As stated, rating concepts can be used to arrive at an overall rating using other traits or characteristics all in a supplementary manner for rating an individual on a wider range of attributes which could include, for example, attributes such as criminal history, residential stability, length of residence, personal health, financial stability and other areas that could be used in the overall rating score. Such a rating system could foreseeably envision a broad array of factors each of which are evaluated and presented separately or factored into the entire overall rating result using mathematical or other methods. For any particular rating area such as identity, credit worthiness, employment history and so forth, a system could mathematically be set forth, in a simplistic format as:
RT=RA1+RA2+RA3 . . . +RAn . . . −RT
Where:
RT=Total Rating Factor
RA1=Rating attribute 1
RA2=Rating attribute 2
RA3=Rating attribute 3
RAn=Rating attribute N
   Such system, using the foregoing approach, could utilize a particular rating factor or utilize multiple rating scores or a combined total score for an overall score. Such an overall system could mathematically be set forth, in a simplistic format as:
   RT=(Overall Rating) RF1+RF2+RF3 . . . +RFN=RT
   Where RT equals the total overall rating considering all relevant characteristic factors of specified individual areas, and specifically where RT is the total overall identity and/or credit worthiness rating for the individual involved. Further RFI is the rating factor for personal identity authentication, RF2 is the overall rating for the credit history, and RF3 is the overall rating factor for residually stability, as so forth as potentially including ratings of other personal attributes. It is noted that there are many other areas about an individual's character and habits, not just identity and credit. For instance, health, financial stability, and total net worth are some of the numerous factors that can be considered to ascertain and rate the identity and credit worthiness of an individual.

One of the reasons that additional factors may or may not be injected into the system, is that identity verification with or without an isolated credit rating, for example, may not per se yield enough to determine a good credit risk, and verified identity alone may not be sufficient in today's perspective to make a decision about approval of an individual. For example an individual's health or job stability may be as much as a factor in determining whether the individual will be able to pay off a loan, or other obligations. In similar manner as stated, such other factors as employment history, residence stability, age, occupation, overall wealth, as well as many other personal characteristic factors can be placed into the equation. Obviously there are many other factors which are important and essential for consideration in this process, as can be easily observed from this formulation. In factoring all of these possible factors, it is that the individual characteristic category can be determined independently for eventual input into the overall score or rating for ultimate approval in a given situation. In other words, a prospective credit provider or other entity may want to have access to the scoring on many attribute areas.

As briefly stated above, from an overall mathematical approach, the process herein involves a calculation system to arrive at a combined identity or uncombined identity rating with individual scoring or rating for identity validity and scoring for credit worthiness with the potential for a combined score for these areas.

As set forth above, the content of combined identity ratings with credit ratings may be supplemented with other individual traits or histories for rating an individual on a wider range of attributes that could include, for example, attributes such as criminal history, residential stability, length of residence, health, and other areas that would be used. Such a rating system could foreseeably envision an array of factors each of which are evaluated and factored into the entire overall rating of the individual, along with credit and identity authentication. Such an overall system could also mathematically utilize an averaging effect as set forth immediately below:

$$\begin{matrix}RT = \underline{( Averaged Overall Rating )} & \frac{R1 + R2 + R3 + R4 … + N}{N}\end{matrix}$$

Where:
N=number of areas analyzed.

Again any separate areas can be separately and independently observed for consideration on the merits of such scoring; and then additionally the total of each factor is placed in the linear equation with the final overall score based on the average of all factors used, as stated in the above equation.

Taking the mathematical analysis one step further, the final average score can be set on a sliding scale, for example, of 1 to 1000 score with a designation of a mean average score to reflect statistically what percentile an individual's score falls within as compared to the general population. Other convenient statistical groupings based on probability factors as a statistical sample in the relevant universe (general population of adults in the country) may be used to achieve an accuracy level of 95% or better or at some other confidence level appropriate to the circumstances.

In another mathematical representation of the process focusing only on credit and identity rating used to arrive at the end result of the scoring of the subject individual rating, such a formulation would include the averaging approach discussed above.

$$= \frac{R1 + R2 … = RT}{2} ( overall Rating )$$

RT=Total Average Rating (using only identity rating and credit rating)
R1=Credit Rating Score, and;
R2=Identity rating Score, and;
RT=Final Score based on average of two factors used.

In this latter formulation, RT is statistically compared as a percentile in the general population and then set in a statistical percentile format as compared to a mean score for the relevant adult population and compared using a percentile basis.

Still another aspect that must be considered in this systematic approach is that an average score based on a limited number of factor areas is that the overall scoring may be worth less, from a subjective or objective analysis, if a person who is otherwise not financially strong may score high on the credit rating area and possibly on the identity issue. If, the individual had one loan and paid it timely, his credit rating would be high, and if his or her identity issue is strong, as the majority of persons are, there would be a high average score on these two rating areas. Other factors may need to be added to the matrix to essentially determine one's ability to fulfill an obligation.

As discussed above previously, a person's credibility and financial ability to properly respond and honor an obligation is projected and accurately foreseen by more than one factor about the history and attributes of an individual. For example as discussed, one's health, marital stability, residual stability, job stability, total net worth, are some of the numerous factors that will properly and accurately foretell one's ability to repay a loan or honor an obligation. Optimally and ideally, all are factors that should be considered in the overall analysis. In this regard, if one has serious or significant health problems and substantial marital problems his or her financial responsibility will be usually hampered. Consequently these factors need to be considered in the overall matters and averaged out. The ultimate redemptive feature in this process is that if some component factors are weak, the other factors to be considered in the equation may be strong to improve the final result. The point that is to be stressed from these myriad considerations, is that the fewer the factors that are placed into the averaging equation, the less strength there is in the final average rating and conversely, the more such factors that are in the final averaging, the more meaningful and accurate the representation and portrayal of an individuals strength will be. To this end, it would be mathematically and otherwise appropriate to factor into the averaging equation a factor that would increase the strength or value of the final average as the number of input considerations are increased. Thus, the use of three factors in the evaluation process would yield a resultant average which would be of more strength than if two are used, and four would be even greater, and so forth, and thus the end results of the averaging process would need to be augmented proportionally based on the increased number of factors used in the process.

One additional aspect that must be considered in respect to the subject invention is that the necessary objectivity that is to be injected into the system will depend to a large extent on a pragmatic approach to assessment of data and also objective standards for a given category. Thus, overviewing the category of residential stability as one potential factor, if a person who is to be rated has had only one primary residence for ten years previously, he will be given a rating of “10” as a score. In this respect, if there have been two primary residential addresses in ten years the rating score could be “9.” A score of “8” could be given for three residences in ten years and so forth in similar fashion as the number of residences increases. Other individual attribute areas would be scored accordingly. As each category is analyzed or rated in the approximate fashion stated above, it would be appropriate and optimal to maintain a “10” or “100” rating score accordingly as the top score in each category, unless it is determined that any particular category should be given a higher top rating amount, such as “200” or “300.” If it is determined that a given category is three times as important as another, such as credit rating, it would have a top score of “300” as opposed to “100” for other areas. The identity authentication area may be rated even higher.

It must be noted that the foregoing mathematical models are just limited examples of the myriad array of mathematical or other arrangements that can be used in conjunction with the subject invention, as other possible algorithmic formulas, or other calculations, tabulations, and means may be used in conjunction with implementing the processes herein to reach a final ultimate rating or scoring or results. Therefore the subject invention shall not be limited to such stated arrangements.

Moreover, in the process of specifically implementing the subject invention, from a practical point of rule, the individual will seek application to the central processing company to become a member and may be requested to provide some or all of the following items for the identity rating process:
1. Passport photo;
2. Thumbprint;
3. Name;
4. Social security number;
5. Three years of IRS W2 forms from the Internal Revenue Service;
6. Street address, city, state, and country of residence for the past ten years;
7. Phone number;
8. E-mail address;
9. Credit card numbers, bank account numbers, consumer loans, etc.;
10. Copies of utilities, loan statements, etc . . . ,;
11. Education data.

Other items or information may be required in the process depending on the entities involved and individuals.

The applicant will, at the option of the rating entity, have the application notarized. In order to process the application of an individual, it is optimal, but not too critical, to utilize the following pragmatic steps. The notary will be required to note that the photograph of the individual is in fact of the applicant and attach it to the application and may physically take the thumbprint of the applicant with an ink pad that is provided in the application kit. Once the application is received, the central processing company will place all such data of the applicant into a data system. Once the verification has been completed, the applicant should be given a Personal Identification Code. Using the personal identification code the applicant will be able to:
1) Update personal data, such as an e-mail address, a postal address, or a phone number.
2). Verify that an electronically signed document was sent.
3) Verify that an application for credit, mobile phone service, change of address, and so forth, that was presented to a member institution with the applicant's personal information, was actually presented by the applicant. Any of the above processes can also be initiated by sending an e-mail or other means to the member to login, calling by telephone, or by other means to the central processing system to verify the digitally signed document or application. The applicant will be able to access the system by way of telephone, Internet, or other means available.

In this later respect, the motivation for a consumer to register with the processing company would be as follows:
a.) To avoid loss of credit by identity theft.
b.) To avoid such matters as a fraudulent attempt to obtain a driver's license by others.
c.) To avoid having one wrongfully change the address of a consumer's credit card to an unauthorized address (which is done to obtain a duplicate card).
d.). Other areas of loss prevention.

The longer a person, individual, or consumer is registered with the centralized processing company the higher the identity score could be, just as a higher credit rating is assigned to a consumer registered with a particular agency for a long period of time. A higher identity score will also provide a basis for better credit terms, and the ability to open an account, and the ability to change personal information.

As indicated, a member institution will request from the processing company a validation number to validate a new applicant, or if one of its customers requests a change of address, e-mail, phone number, etc, the processing company will provide various means for the institution members to make inquiries into its respective systems, namely: C++ library (™), Java library (™), Web interface (HTTP)(™) or any other means that the institution member needs. The member institution will submit some or all of the following: Social security number, name, address, phone number(s), e-mail address (which would be optional), and transaction type whether it is a new application or change of address. The processing company will send back scores from 0-1000, using the subject process. At no time will the member institution obtain personal information from the processing company if the individual elects to keep same private or confidential. Part of the advantage of the system is when more institutions use the processing company system to validate new applications or changes of personal information, a substantial bank of information is accumulated.

In a general perspective, a member institution to which an individual applies, receives an application for a credit card, bank loan, mobile phone service, driver's license, system access, or requests to change personal information on an existing account, will use this system for such purposes. If the applicant is entered into the subject system herein, such individual will be able to register that he or she has applied for credit and/or signed a document or other access with a particular institution. When the central processor in this system receives a request for verification from the member institution there will be an identity authentication score sent back optionally with an additional verification rating, which will be based on a standardized system on a national basis.

In an overall perspective the subject invention is a system of rating individuals for identity authentication and other personal attributes using one or more personal characteristics, each characteristic having a graded scale for rating of that particular characteristic, and then adding the individual rating score for each designated characteristic to provide an overall rating for authentication of identity of the individual, or additional verification rating attribute areas. This rating process can encompass a rating used for credit applications, matters relating to digital signature of documents, aspects concerning changing of personal information within established third party accounts, matters involving employment applications, and other involvement in institutional admissions or for any other purpose in which an individual applies to or for and is not just limited to those areas specified by way or example. Included in these other areas can be requests for employment, verification for employment, verification of employment, verification of income, or admission to a school.

### DESCRIPTION OF PREFERRED EMBODIMENT

In describing the preferred embodiment of the subject invention, it is to be stressed that by describing one preferred embodiment of the subject invention as it more fully delineated below, it shall not restrict or limit the scope of the subject invention as set forth in the description and the claims appended hereto. Therefore, additional embodiments not specifically mentioned herein will not be excluded.

Initially, in an overall perspective, the subject invention is a system of rating an individual for identity purposes and other areas using one or more personal identity characteristics, each such characteristic having a graded scale for rating of that particular characteristic, and then adding an individual rating score for each designated characteristic to provide an overall rating for authentication of identity of the individual. These rating processes can encompass ratings used for credit applications, employment applications, and other institutional admissions or for any other purpose in which an individual applies to or for and is not just limited to those specified above. Included can be requests for employment or admission to school, among a myriad of other circumstances.

In a general perspective, a member institution to which an individual applies, receives an application for a credit card, bank loan, mobile phone service, driver's license system access, or requests to change personal information on an existing account, will use this system or other access or admissions. If the applicant is entered in the subject system herein, such individual will be able to register that he or she has applied for credit and/or signed a document for other access with a particular institution, entity, or individual. When the central processor in this system receives a request for verification from the member institution there will be an identity authentication score sent back optimally with an additional verification rating, which will be based on a standardized system on a national basis.

The subject invention comprises a process and means for integrated procedures to obtain a standardized identity or credit worthiness rating for individuals seeking credit or for those using electronic signatures or making personal information changes on established accounts or for gaining access to an institution comprising of the steps of utilizing a scaled mathematical or other rating system for such areas. The overall processing system includes the basic steps outlined below.

Alternately stated, the subject invention is a system of rating individuals for identity authentication and other personal attributes using one or more personal characteristics, each characteristic having a graded scale for rating of that particular characteristic, and then adding the individual rating score for each designated characteristic to provide an overall rating for authentication of identity of the individual, or additional verification rating attribute areas. This rating process can encompass a rating used for credit applications, matters relating to digital signature of documents, aspects concerning changing of personal information within established third party accounts, matters involving employment applications, and other involvement in institutional admissions or for any other purpose in which an individual applies to or for and is not just limited to those areas specified by way or example. Included in these other areas can be requests for employment, verification for employment, verification of employment, verification of income, or admission to a school, and other areas.

From an overall mathematical or other processing approach, the system herein involves calculating using a procedure to arrive at a combined identification validity rating along with other personal attributes. In this process individuals can be rated for identity as well as for credit worthiness with individual scoring, resulting in a verification rating for other identity and possibly other personal attributes.

As stated, rating concepts can be used to arrive at an overall rating using other traits or characteristics all in a supplementary manner for rating an individual on a wider range of attributes which could include, for example, attributes such as criminal history, residential stability, length of residence, personal health, financial stability and other areas that could be used in the overall rating score. Such a rating system could foreseeably envision a broad array of factors each of which are evaluated and presented separately or factored into the entire overall rating result using mathematical or other methods. For any particular rating area such as identity, credit worthiness, employment history, and so forth, a system could mathematically be set forth, in a simplistic format as:
RT=RA1+RA2+RA3 . . . +RAn . . . =RT
Where:
RT=Total Rating Factor
RA1=Rating attribute 1
RA2=Rating attribute 2
RA3=Rating attribute 3
RAn=Rating attribute N
   Such system using the foregoing approach could utilize a particular rating factor or utilize multiple rating scores or a combined total score for an overall score. Such an overall system could mathematically be set forth, in a simplistic format as:
   RT=(Overall Rating) RF1+RF2+RF3 . . . +RFN=RT
   Where RT equals the total overall rating considering all relevant characteristic factors of specified individual areas, and specifically where RT is the total overall identity and/or credit worthiness rating for the individual involved. Further, RFI is the rating factor for personal identity authentication, RF2 is the overall rating for the credit history, and RF3 is the overall rating factor for residential stability, and so forth as potentially including ratings of other personal attributes. It is noted that there are many other areas about an individual's character and habits, not just identity and credit. For instance, health, financial stability, total net worth, etc., are some of the numerous factors that can be considered to ascertain and rate the identity and credit worthiness of an individual.

One of the reasons that additional factors may or may not be injected into the system, is that identity verification with or without an isolated credit rating, for example, may not per se yield enough to determine a good credit risk, and verified identity alone may not be sufficient in today's perspective to make a decision about approval of an individual For example, an individual's health or job stability may be as much as a factor in determining whether the individual will be able to pay off a loan, or other obligations. In similar manner as stated, such other factors as employment history, residence stability, age, occupation, overall wealth, as well as many other personal characteristic factors may be placed into the equation. Obviously, there are many other factors which are important and essential for consideration in this process. As can be easily observed from this formulation and factoring of all these possible factors, it is that the individual characteristic category can be determined independently for eventual input into the overall score or rating for ultimate approval in a given situation. In other words, a prospective credit provider or other entity may want to have access to the scoring on many attribute areas.

As briefly stated above, from an overall mathematical approach, the process herein involves a calculation system to arrive at a combined identity or uncombined identity rating with individual scoring or rating for identity validity and scoring for credit worthiness with the potential for a combined score for these areas.

As set forth above, the content of combined identity ratings with credit ratings may be supplemented with other individual traits or histories for rating an individual on a wider range of attributes that could include, for example, attributes such as criminal history, residential stability, length of residence, health, and other areas that would be used. Such a rating system could foreseeably envision an array of factors each of which are evaluated and factored into the entire overall rating of the individual, along with credit and identity authentication. Such an overall system could also mathematically utilize an averaging effect as set forth immediately below:

$$\begin{matrix}RT = \underline{( Averaged Overall Rating )} & \frac{R1 + R2 + R3 + R4 … + N}{N}\end{matrix}$$

Where:
N=number of areas analyzed.

Again, any individual areas can be separately and independently observed for consideration on the merits of such scoring; and then, additionally, the total of each factor is placed in the linear equation with the final overall score based on the average of all factors used, as stated in the above equation.

Taking the mathematical analysis one step further, the final average score can be set on a sliding scale, for example, of a 1 to 1000 score with a designation of a mean avenge score to reflect statistically what percentile an individual's score falls within as compared to the general population. Other convenient statistical groupings based on probability factors as a statistical sample in the relevant universe (general population of adults in the country), may be used to achieve an accuracy level of 95% or better or at some other confidence level appropriate to the circumstances.

In another mathematical representation of the process focusing only on credit and identity rating used to arrive at the end result of the scoring of the subject individual rating, such a formulation would include the averaging approach discussed above.

$$= \frac{R1 + R2 … = RT}{2} ( overall Rating )$$

RT=Total Average Rating (using only identity rating and credit rating);
R1=Credit Rating Score; and
R2=Identity rating Score; and
RT=Final Score based on average of two factors used.

In this latter formulation, RT is statistically compared as a percentile in the general population and then set in a statistical percentile format as compared to a mean score for the relevant adult population and compared using a percentile basis.

Still another aspect that must be considered in this systematic approach is that an average score based on a limited number of factor areas, is that the overall scoring may be worth less, from a subjective or objective analysis. Thus, if a person who is otherwise not financially strong may score high on the credit rating area and possibly on the identity issue. If the individual had one loan and paid it timely, his credit rating would be high, and if his or her identity issue is strong, as the majority of persons are, there would be a high average score on these two rating areas. Other factors may need to be added to the matrix to essentially determine one's ability to fulfill an obligation.

As discussed above previously, a person's credibility and financial ability to properly respond and honor an obligation is projected and accurately foreseen by more than one factor about the history and attributes of an individual. For example, as discussed, one's health, marital stability, residual stability, job stability, and total net worth are some of the numerous factors that will properly and accurately foretell one's ability to repay a loan or honor an obligation. Optimally and ideally all are factors that should be considered in the overall analysis. In this regard, if one has serious or significant health problems and substantial marital problems, his or her financial responsibility will usually be hampered. Consequently, these factors need to be considered in the overall matters and averaged out. The ultimate redemptive feature in this process is that if some component factors are weak, the other factors to be considered in the equation may be strong to improve the final result. The point that is to be stressed from these myriad considerations, is that the fewer the factors that are placed into the averaging equation, the less strength there is in the final average rating and conversely, the more such factors that are in the final averaging, the more meaningful and accurate the representation and portrayal of an individuals strength may be. To this end it would be mathematically and otherwise appropriate to factor into the averaging equation so used a factor that would increase the strength or value of the final average as the number of input considerations are increased. Thus, the use of three factors in the evaluation process would yield the resultant average which would be of more strength than if two are used. Four would be even greater and so forth, and thus the end results of the averaging process would need to be augmented proportionally based on the increased number of factors used in the process.

One additional aspect that must be considered in respect to the subject invention is that the necessary objectivity that is to be injected into the system will depend to a large extent on a pragmatic approach to assessment of data and also objective standards for a given category. Thus, overviewing the category of residential stability as one potential factor, if a person who is to be rated has had only one primary residence for ten years previously, he will be given a rating of “10,” as a score. In this respect, if there have been two primary residential addresses in ten years the rating score could be “9.” A score of “8” will be given for three residences in ten years and so forth in similar fashion as the number of residences increases. Other individual attribute areas would be scored accordingly. As each category is analyzed or rated in the approximate fashion stated above, it would be appropriate and optimal to maintain a “10” or “100” rating score accordingly as the top score in each category, unless it is determined that any particular category should be given a higher top rating amount, such as “200” or “300.” If it is determined that a given category is three times as important as another, such as credit rating, it would have a top score of “300” as opposed to “100” for other areas. The identity authentication area may be rated even higher.

It must be noted that the foregoing mathematical models are just limited examples of the myriad array of mathematical or other arrangements that can be used in conjunction with the subject invention, as other possible algorithmic formulas, or other calculations tabulations means may be used in conjunction with implementing the processes herein to reach a final ultimate rating or scoring or results. Therefore the subject invention shall not be limited to such stated arrangements.

Moreover, in the process of specifically implementing the subject invention, from a practical point of rule, the individual will seek application to the central processing company to become a member and may be requested to provide some or all of the following items for the identity rating process:
1. Passport photo;
2. Thumbprint;
3. Name;
4. Social security number;
5. Three years of IRS W2 forms from the Internal Revenue Service;
6. Street address, city, state, and country of residence for the past ten years;
7. Phone number;
8. E-mail address;
9. Credit card numbers, back account numbers, consumer loans, etc.;
10. Copies of utilities, loan statements, etc . . . ;
11. Education data.

Other items or information may be required in the process depending on the entities involved and individuals involved.

The applicant will, at the option of the rating entity, have the application notarized. In order to process the application of an individual, it is optimal, but not too critical, to utilize the following pragmatic steps. The notary will be required to note that the photograph of the individual is in fact the applicant and attach it to the application and may physically take the thumbprint of the applicant with an ink pad that is provided in the application kit. Once the application is received, the central processing company will place all such data of the applicant into a data system Once the verification has been completed, the applicant should be given a Personal Identification Number Code. Using the personal identification code the applicant will be able to:
1) Update personal data, such as an e-mail address, postal address, and phone number.
2) Verify that an electronically signed document was sent.
3) Verify that an application for credit, mobile phone service, change or address or so forth, that was presented to a member institution with the applicant's personal information, was actually presented by the applicant. Any of the above can also be initiated by sending an e-mail or other means to the member to login, calling by telephone, or by other means to the central processing system to verify the digitally signed document or application. The applicant will be able to access the system by way of telephone, Internet, or other means available.

In this later respect, the motivation for a consumer to register with the processing company would be as follows:
a.) To avoid loss of credit by identity theft.
b.) To avoid such matters as a fraudulent attempt to obtain a driver's license by others.
c.) To avoid having one wrongfully change the address of a consumer's credit card to an unauthorized address (which is done to obtain a duplicate card).
d.). Other areas of loss prevention.

The longer a person, individual, or consumer is registered with the centralized processing company the higher the identity score could be. Just as a higher credit rating is given a consumer registered with an agency for a long period of time, a higher identity score will result as an improved basis for better credit terms, and the ability to open an account, and the ability to change personal information.

As indicated, a member institution will request from the processing company a validation number to validate a new applicant, or if one of its customers requests a change of address, e-mail, phone number, etc, the processing company will provide various means for the institution members to make inquiries into its systems, namely: C++ library (™), Java library (™), Web interface (HTTP)(™) or any other means that the institution member needs. The member institution will submit some or all of the following: Social security number, name, address, phone number(s), e-mail address (which would be optional), and transaction type whether it is a new application or change of address. The processing company will send back score from 0-1000,using the subject process. At no time will the member institution obtain personal information from the processing company if the individual elects to keep same private or confidential. Part of the advantage of the system is when more institutions use the processing company system to validate new applications or changes of personal information, the greater the bank of information, thus enhancing the validity status.

In a general perspective a member institution, to which an individual applies, receives an application for a credit card, bank loan, mobile phone service, driver's license system access or requests to change personal information on an existing account, will use this system or other access or admissions. If the applicant is entered in the subject system herein such individual will be able to register that he or she has applied for credit and/or signed a document or other access with a particular institution. When the central processor in this system receives a request for verification from the member institution there will be an identity authentication score sent back optionally with an additional verification rating, which will be based on a standardized system on a national basis.

In an overall perspectives the subject invention is a system of rating individuals for identity authentication and other personal attributes using one or more personal characteristics, each characteristic having a graded scale for rating of that particular characteristic, and then adding the individual rating score for each designated characteristic to provide an overall rating for authentication of identity of the individual, or additional verification rating attribute areas. This rating process can encompass a rating used for credit applications, matters relating to digital signature of documents, aspects concerning changing of personal information within established third party accounts, matters involving employment applications, and other involvement in institutional admissions or for any other purpose in which an individual applies to or for and is not just limited to those areas specified by way or example. Included in these other areas can be requests for employment, verification for employment, verification of employment, verification of income, or admission to a school.

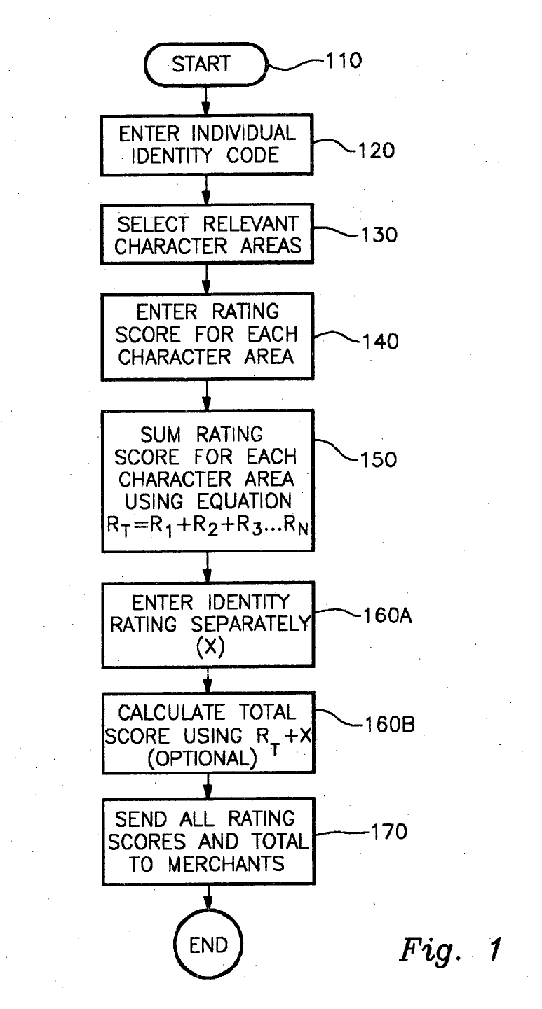

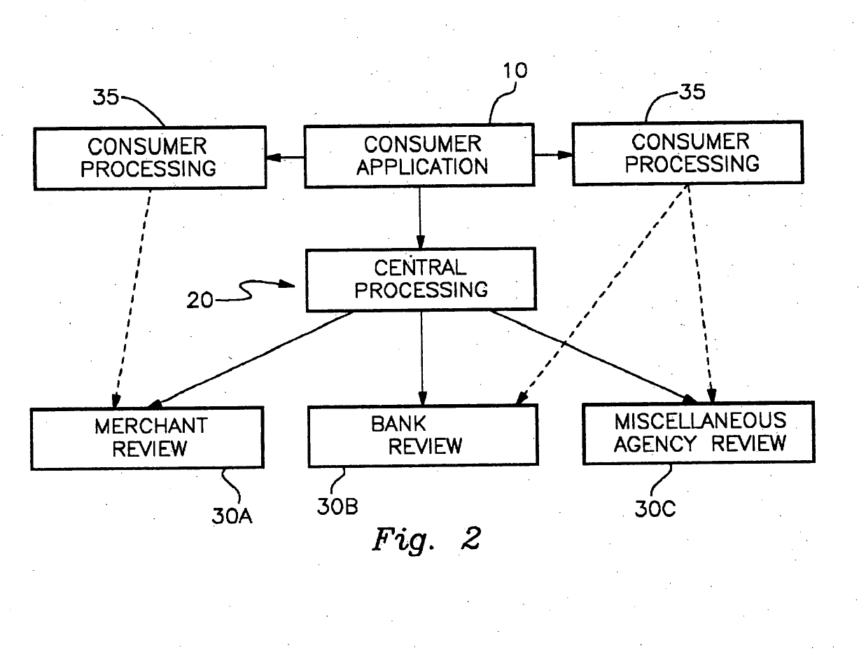

In implementing the subject algorithmic approach, in conjunction with the foregoing practical aspect, attention is directed to FIGS. 1 and 2 of the drawings. Shown in FIG. 2 is an overall schematic diagram of the overall interrelationship of the parties and individuals involved in the system. Specifically seen in FIG. 2 is a representation of the consumer “10” relative to the processing center “20” and the sundry merchant, banks and other user entities 30A, 30B, 30C. Moreover, as seen in FIG. 1, the consumer “10” applies initially to the processing center 20 for identity verification and or credit worthiness standing. Once this latter status is established, the central process center 20 will relay this verification information to merchants or other entities such as the merchant, banks, or other entities, and so forth who are subsequently contacted by the individual consumer 10, and which entities will request personal information and identification authenticity for credit or other status.

Turning again to FIG. 1, shown is a schematic of a computer program processing flow diagram 100 of the overall processing system used in conjunction with the subject system. As seen in FIG. 1, the program commences with an input entry 110 to start the processing. Once the program is activated, the personal identity code for a given individual is entered into the computer system, as seen in operation sequence 120. Thereafter the next operational step 130 is to select the relevant characteristic areas to be scored or established as based on authentication data provided by the individual applying. Once these characteristics areas are selected, the rating score for each characteristic area is then entered as the next subsequent operation 140. Once the rating score for each identity characteristic area is determined under step 140, the next operational step 150 is to total the operation scores of each characteristic area through the following equation.
RT=R1+R2+R3+R4 . . . +RN

The latter step may include an additional averaging function as set forth above. Once the latter steps have been completed the resultant total score is entered as step 160 and the total score RT scoring for identity authentication are relayed 170 electronically or otherwise to the merchant or other entity using the identity score. This ends the program sequence.

In summary, the subject invention is an identity authentication system for verifying the true identity of an individual and providing same to an entity seeking such identity authentication of such individual, comprising:
(a) collecting multiple information aspects relating to the identity of such individual; and
(b) assigning rating scores for each of such information aspects of such individual; and
(c) adding each of such rating scores for each such information aspect for a total rating score for such identity authentication, system, and
(d) providing such rating score to such entity seeking identity authentication of such individual.

Additionally, summarizing, the subject invention is an identity authentication system for verifying the true identity of an individual and providing same to an identity seeking such identity authentication of such individual comprising:
(a) collecting multiple information aspects relating to the identity of such individual; and
(b) assigning numerical scores for each of such information aspects of such individual; and
(c) adding each of such numerical scores for each such information aspects for a total numerical score for such identity authentication; and
(d) providing such numerical score to such entity seeking identity authentication of such individual.

Further summarizing, the subject invention is an identity authentication system for verifying the true identity of an individual and providing same to an entity seeking: such identity authentication of such individual, comprising:
(a) accumulating identity information about an individual; and
(b) placing such identity information into a computer program; and
(c) placing a mathematical score on such accumulated identity information of such individual.

Yet another summary of the subject invention is that it is an identity authentication system for verifying the true identity of an individual and providing same to an entity seeking such identity authentication of such individual, comprising:
(a) accumulating identity information about an individual;
(b) placing such identity information into a computer program;
(c) placing a mathematical score on such accumulated identity information of such individual.

Still another summary of the subject invention is a system for authenticating the identity status of an individual for establishing such individual's identity status, comprising:
(a) collecting multiple information aspects relating to the identity of such individual;
(b) assigning rating scores for each of such information aspects of such individual;
(c) adding each of such rating scores for each, such information aspects for a total rating score for such identity authentication;
(d) providing such rating score to such entity seeking identity authentication of such individual.

Further summarizing the subject invention, it is a system for rating credibility of an individual among various individuals establishing one or more credibility traits for rating purposes, establishing a mathematical rating scale for each of such credibility traits as follows:
RT=R1+R2+R3 . . . +RN
Where RT=total rating score
and R1, R2, R3 and RN are individual credibility traits.

Yet a further summary of the subject invention is that it is a system for rating credibility worthiness of an individual comprising of the following steps:
(a) assigning various categories to rate an individual;
(b) providing a rating scale for each of such categories;
(c) calculating an overall rating score for the total of each such rated category using a computer means to calculate same.

1: An identity authentication system for verifying the true identity of an individual and providing same to an entity seeking said identity authentication of said individual, comprising:
(a) collecting multiple information aspects relating to the identity of said individual;
(b) assigning rating scores for each of said information aspects of said individual;
(c) adding each of said rating scores for each said information aspect for a total rating score for said identity authentication, system;
(d) providing said rating score to said entity seeking identity authentication of said individual.

2: An identity authentication system for verifying the true identity of an individual and providing same to an identity seeking said identity authentication of said individual:
(a) collecting multiple information aspects relating to the identity of said individual;
(b) assigning numerical scores for each of said information aspects of said individual;
(c) adding each of said numerical scores for each said information aspects for a total numerical score for said identity authentication, said addition being accomplished by computer means;
(d) providing said numerical score to said entity seeking identity authentication of said individual.

3: An identity authentication system for verifying the true identity of an individual and providing same to an entity seeking said identity authentication of said individual, comprising:
(a) accumulating identity information about an individual;
(b) placing said identity information into a computer program;
(c) placing a mathematical score on said accumulated identity information of said individual;
(d) adding the total of said mathematical scores on said accumulated identity information for a total identity authentication system.

4: An identity authentication system for verifying the true identity of an individual and providing same to an entity seeking said identity authentication of said individual, comprising:
(a) accumulating identity information about an individual;
(b) placing said identity information into a computer program;
(c) placing a mathematical score on each of said accumulated identity information of said individual, and adding said total score of all accumulated identity information.

5: A system for authenticating the identity status of an individual for establishing said individual's identity status:
(a) collecting multiple information aspects relating to the identity of said individual;
(b) assigning rating scores for each of said information aspects of said individual;
(c) adding each of said rating scores for each, said information aspects for a total rating score for said identity authentication, said adding accomplished through computer processing means;
(d) providing said resultant rating score to said entity seeking identity authentication of said individual.

6: A system for rating credibility of an individual among various individuals establishing one or more credibility traits for rating purposes, establishing a mathematical rating scale for each of said credibility traits through computer processing through the following formulations:
RT=R1+R2+R3 . . . +RN
Where RT=total rating score
and R1, R2, R3 and RN are individual credibility traits.

7: A system for rating credibility worthiness of an individual comprising of the following steps:
(a) assigning various categories to rate an individual;
(b) providing a rating scale for each of said categories;
(c) calculating an overall rating score for the total of each said rated category using a computer means to calculate same.

8. A method for a system which generates a credibility rating for individuals and organization entities based upon validity of identity facts and credibility of an entity comprising:
collecting multiple information aspects relating to the identity and credibility of said entity and entering same in a computer;
evaluating and assigning rating scores for each of said information aspects of said entity and processing same is said computer;
and adding said rating scores for a total rating score of the credibility of said entity through said computer.

9. A method for a system which generates a credibility rating for individuals and organization entities based upon validity of identity facts and credibility of an entity comprising:
collection means for collecting multiple information aspects relating to the identity and credibility of said entity, said collection information aspects entered into a computer;
evaluation means for evaluating and assigning rating scores for each of said information aspects of said entity, using said computer to process said scores;
and a calculator for adding said rating scores for a total rating score of the credibility of said entity, using said computer to said adding.
